(19) United States
(12) Patent Application Publication
(10) Pub. No.: US 2001/0050978 A1
(43) Pub. Date: Dec. 13, 2001

(54) GENERIC DISTRIBUTED MESSAGE BOX

(76) Inventor: BJORN JONSSON, JARFALLA (SE)

Correspondence Address: RICHARD J MOURA, JENKENS & GILCHRIST, 3200 FOUNTAIN PLACE, DALLAS, TX, 75202

(21) Appl. No.: 09/103,696

(22) Filed: Jun. 24, 1998

(51) Int. Cl. H04M 1/64

(52) U.S. Cl. 379/88.25; 379/88.22

(57) ABSTRACT

A system and method are disclosed, which include an arrangement of message boxes that can be readily accessed by users from different communication networks. The storage of messages addressed to a user can reside on nodes at various locations. The location of the messages at each instant is controlled by a service computer or “Personal Assistant”. As such, the storage and retrieval of such a message can be described as a type of “meeting,” whereby simultaneous connectivity between the attending message sender and intended recipient is not required.

### BACKGROUND OF THE INVENTION

1. Technical Field of the Invention

The present invention relates in general to the communication network services field and, in particular, to a method for organizing message boxes for access via one or more communications networks.

2. Description of Related Art

A personal message box (e.g., for storing voice mail messages, facsimile messages, e-mail or other text messages, multimedia, etc.) is presently a common and valued service offered by communication network operators as a complement to ordinary voice services and other real-time services. As such, the format of a stored message can vary and comprise, for example, textual, verbal or visual information. Accordingly, many mobile phone users appreciate an opportunity to be able to convert a message to a different format than what was originally stored.

Certain communication systems are now capable of rerouting an unanswered telephone call to a service node that includes a voice message box. For example, certain telecommunications networks called Intelligent Networks (INs) provide relatively new communication capabilities and services that make it possible for subscribers to have their own personal mailboxes. These mailboxes can store messages having various formats including, for example, voice messages, facsimile messages, and e-mail. These INs typically include functions for converting from one message format to another.

A type of personal message box now available for use in cellular communication networks is the textual Short Message Service (SMS) provided in the Global System for Mobile Communications (GSM). On the computer network side, personal message boxes are typically associated with unique entries to databases, which are capable of storing data in various formats such as voice, text or graphics.

Methods currently exist for converting a message from one format to another, such as, for example, a format that is more suitable for a user at a particular point in time. Such conversion methods can be used in services that allow a user enough flexibility to select an appropriate terminal to read a stored message, once the user has been notified about its registration in a mailbox.

PCT Application No. WO-9620553, titled “Unified Messaging and Long Distance Communication System,” discloses a method for integrating a public network and a data network in order to transfer messages from a sender to a receiver's mailbox. The receiver can then be notified about a new message. Also, a method is disclosed for converting the format of a message, in order to reroute it to a selected terminal.

A problem related to the handling of messages having different formats is disclosed in U.S. Pat. No. 5,333,266, titled “Method and Apparatus for Message Handling in Computer Systems,” which describes an integrated messaging system. A computer network is disclosed which includes a plurality of servers. Each server handles a specific message format. Consequently, any network terminal user can generate and/or retrieve a message in any of the available formats. As such, in order for a user to be able to keep track of incoming messages at one particular server, a message pointer is copied to all other servers in the network.

Existing solutions (e.g., for INs) for problems associated with integrating message services located at different nodes in different networks, depend on the levels of cooperation existing between the network operators involved. Similarly, third parties attempting to set up message service capabilities typically have to negotiate cooperative agreements with each of the network operators involved. Also, each network operator may use different user dialogues, which can require additional cooperative efforts and cause additional inconveniences for users.

One significant disadvantage of the existing solutions for the problem of integrating message services located at different nodes in different networks, is that a message service typically has a fixed “Post Office” in one of the networks involved. However, the location of that “Post Office” often is not the most advantageous from all message recipients' and service providers' points of view. Another significant disadvantage is that the costs for a mailbox are incurred independently of whether or not the mailbox is utilized. Furthermore, the costs for a mailbox are independent of the amount of message data stored. However, users are allocated only limited volumes of data storage. Nevertheless, as described in detail below, the present invention successfully resolves the above-described problems.

### SUMMARY OF THE INVENTION

It is, therefore, an object of the present invention to provide an arrangement of message boxes that can be readily accessed by users from different communication networks.

It is another object of the present invention to provide a virtual personal message box for users in different networks, which is comprised of a plurality of distributed physical storage locations.

It is still another object of the present invention to provide a message service that can be requested and charged for on an as needed basis.

It is yet another object of the present invention to provide a message service that separates the processing of message contents from user dialogue functions.

In accordance with the present invention, a system and method are provided by an arrangement of message boxes that can be readily accessed by users from different communication networks. The storage of messages addressed to a user can reside on nodes at various locations. In addition to storing messages, the message boxes can store similar other information such as, for example, voice prompts, program scripts, web pages, etc. The location of the messages at each instant is controlled by a service computer or “Personal Assistant”. As such, the storage and retrieval of such a message can be best described as a type of “meeting,” whereby simultaneous connectivity between the attending message sender and intended recipient is not required. A method for arranging such a “meeting” is described in U.S. Pat. No. 5,555,298 by the present inventor, titled “Method and System for Establishing a Connection Between Parties in a Network,” which is incorporated herein in its entirety.

An important technical advantage of the present invention is that a third party can set up a message service independent of established operators of telecommunications networks that are required only for basic switching and transmission services.

Another important technical advantage of the present invention is that message service resources are allocated on an as needed basis.

Still another important technical advantage of the present invention is that the location of message services is flexible and can be determined for an effective overall utilization of resources.

Still another important technical advantage of the present invention is that message security is increased, because a stored message only has an identifier associated with it, which is used by a Personal Assistant (service computer) to associate the message with a sender and intended recipient. Consequently, fraudulent access to a stored message will not necessarily provide access to the addressee information.

Still another important technical advantage of the present invention is that the totality of stored messages associated with a particular user can be distributed over several generic message boxes, or a message can be split into separate pieces which can be distributed and stored at separate message boxes. Consequently, a high degree of security against fraudulent access to messages can be obtained. Also, a message can be duplicated and stored in separate boxes, in order to achieve a high degree of reliability against a loss of the message information.

Yet another important technical advantage of the present invention is that a least cost model can be applied, whereby the storage and retrieval of a message at the closest access point can be selected to minimize telecommunication costs. As such, less expensive data communications means can be used to transfer a message file between two access points.

### BRIEF DESCRIPTION OF THE DRAWINGS

A more complete understanding of the method and apparatus of the present invention may be had by reference to the following detailed description when taken in conjunction with the accompanying drawings wherein:

FIG. 1 is a simplified block diagram that illustrates an exemplary system for arranging message boxes, in accordance with a preferred embodiment of the present invention;

FIG. 2 is a simplified block diagram of a system that illustrates a different aspect of the present invention, whereby the switching functions and dialogue server are implemented as functions in a private network interconnected with a plurality of public networks;

FIG. 3 is a simplified block diagram that illustrates a system including a dialogue server with a separate conversion server, which can be used to implement the present invention; and

FIG. 4 is a simplified block diagram that illustrates a message transfer from one box to another.

### DETAILED DESCRIPTION OF THE DRAWINGS

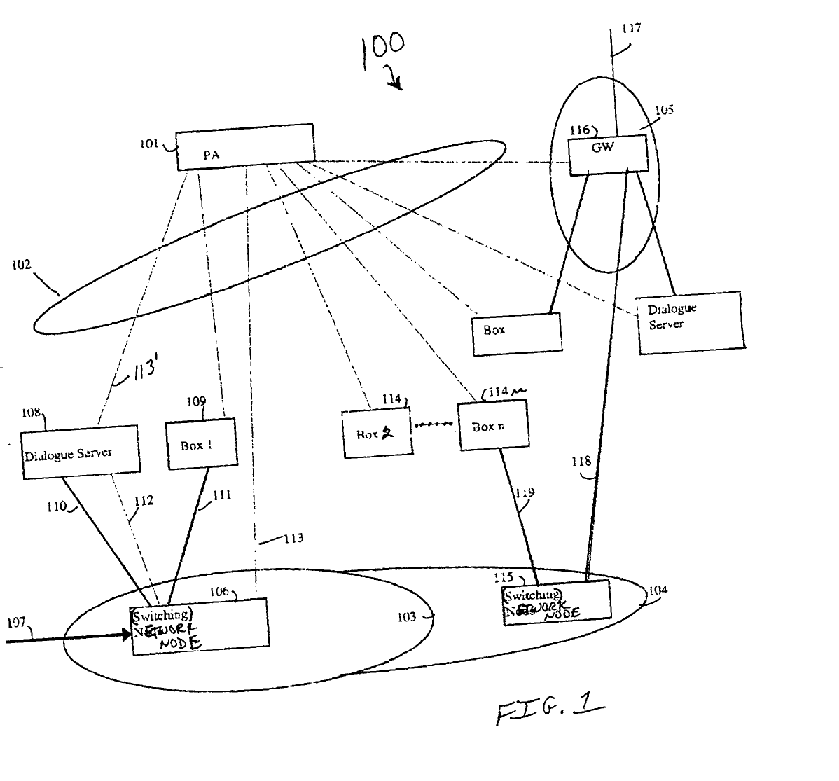

The preferred embodiment of the present invention and its advantages are best understood by referring to FIGS. 1-4 of the drawings, like numerals being used for like and corresponding parts of the various drawings.

FIG. 1 is a simplified block diagram that illustrates an exemplary system and method for arranging message boxes for use by a plurality of telecommunications networks, in accordance with a preferred embodiment of the present invention. Exemplary system 100 includes a Personal Assistant (PA) 101, which can be, for example, a service computer or a server. For this embodiment, incoming calls made to a personal number are redirected to a network node. PA 101 functions primarily to maintain control over further processing of calls in order to effect storage of a message in a selected message box. The same personal number can be used in any one of a plurality of telecommunications networks (e.g., networks 103, 104), which can redirect an incoming call to a final destination box utilizing respective network (e.g., switching) nodes 106 and/or 115. For messages arriving via other networks (e.g., Internet), a corresponding network address is used to indicate a receiver (e.g., an Internet Mail address). For example, telecommunications networks 103, 104 can be Public Land Mobile Networks (PLMNs), or one or both of networks 103, 104 can be an IN, Public Data Network (PDN), or Public Switched Telephone Network (PSTN).

An incoming telephone call 107 can originate in one of a plurality of terminal types that can generate a plurality of message formats, such as, for example, voice, facsimile, or dial-up e-mail. The PA 101 can utilize a signalling network 102 to order a dialogue server (or service node) 108 to establish a dialogue 110 (e.g., receive/send a voice message) with the originating terminal. At a minimum, the dialogue server 108 functions to recognize the format of an incoming call and adapt the currently established dialogue to that format. An exemplary method for establishing such a dialogue is disclosed in commonly-assigned U.S. Pat. No. 5,555,298. Notably, the dialogue established in response to an incoming message can be directly with a person (e.g., voice message), or, for example, between two computers (i.e., through a “man machine interface” with a person). Additionally, the PA 101 can control the network switching functions in a network node 106 via control messages sent over a signalling connection 113. Herein, the dotted lines are intended to denote signalling connections.

Exemplary system 100 also includes a data network 105, which includes a gateway server (or service node) 116 for interconnecting data network 105 with, for example, telecommunications network 104. An incoming data communication 117 can include personal identity information, such as, for example, an e-mail address, which is associated with the PA 101 so that the PA 101 can route the data communication 117 to a selected message box. Notably, similar to the above-described incoming telephone call situation, the data communication 117 can also include such information as a request for a dialogue server to establish a dialogue with the originating terminal. That request, which can be detected by a dialogue server (e.g., 108), can cause the dialogue server to request the PA 101 (via a signalling connection 113′) to reserve one of the plurality of message boxes (109-114n) for future use. Essentially, the PA 101 can “purchase” the message box resources on the resource “market”. For example, in order to do so, the PA 101 can initiate a calculation and registration of costs (i.e., cost per system resource). The PA 101 can make such a message box reservation by obtaining a message box identifier using a stored list of references to message boxes or, alternatively, by requesting a reference from an administrative function. The message box identifier is stored by the PA 101 to be used later when retrieving the stored message upon request by the addressee. The PA 101 maintains the association between individual messages and the corresponding message boxes. In addition, the PA 101 can use a known method to authenticate a user who is requesting access to a message box for retrieval of stored information. As such, the list of information stored in a memory area can also include a key for use in authenticating a user who is requesting access.

The message boxes 109-114n can be connected to the different networks 103, 104, 105. An incoming call 107 or data communication 117 can be routed to and stored in one of those message boxes via a connection 111 and/or 119, respectively. The resulting message can be stored in the appropriate message format used by the respective network 103 or 104.

As mentioned earlier, the PA 101 can control the switching functions in network node 106 via signalling connections 113′ (between the PA 101 and the dialogue server 108) and 112 (between the dialogue server 108 and the network node 106), in order to set up the connections 110 and 111. These control and switching functions can be implemented in a number of conventional ways. Notably, the PA 101 also includes a data storage memory area, which can store a reference to an allocated message box (109-114n), a second reference to an address (location) of a stored message in the allocated message box, and certain message attributes for the stored message (e.g., message format). For example, in order to determine a message format from an e-mail message, the message header can contain the format information. For a voice and/or facsimile message, the receiving equipment can determine the type of message being received. In this way, the PA 101 can maintain a “virtual” personal message box comprising a plurality of distributed physical storage locations (e.g., 109-114n).

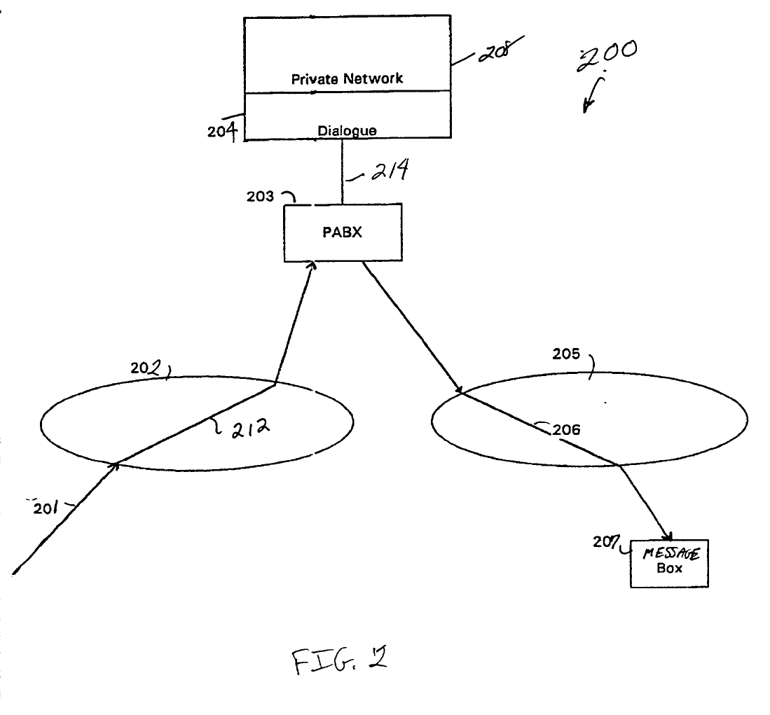

FIG. 2 is a simplified block diagram of a system 200 that illustrates a different aspect of the present invention, whereby the switching functions and dialogue server are implemented as functions in a private network interconnected with a plurality of public networks (e.g., PLMN, PSTN, PDN, etc.). For this exemplary embodiment, an incoming call 201 is redirected via a connection path 212 in a first public network 202 to a Private Branch Exchange (PABX) 203 or any other access node having a corresponding functionality. First, the PABX 203 connects the incoming call 201 to a dialogue function 204 in the private network 208 via a connection path 214. For example, the dialogue function 204 can be implemented by software executed in a processor in the private network 208. The PABX 203 then establishes a connection path 206 in a second public network 205 to a message box 207.

The private network 208 associated with the dialogue function 204 can include a plurality of network nodes (not shown) configured so that an incoming call can be routed to a “closest” network node using a conventional method (e.g., using an “800” telephone number). This routing can be accomplished by using conventional origination location-dependent routing information derived from the incoming message. The destination message box (e.g., 207) is determined by the PA 101 preferably using various information, such as, for example, costs, availability of message boxes, location of receiver, etc. In a similar way, the intended recipient of a message (user) can be connected to a “closest” network node in network 205 that is connected to a message box (e.g., a message box 109-114n shown in FIG. 1). As such, a data link between the message boxes 109-114n is established to enable a transfer of the message ultimately to the intended recipient at the “closest” message box selected.

The addressed party (intended recipient) can be notified about a new (stored) message in a number of ways, such as, for example, by using a paging system. The page message can include the telephone number of the PA 101. As such, once informed by the page, the intended recipient of the message can call the PA 101 via any of the plurality of networks 202, 205 (or, for example, networks 103, 104, 105), in order to read out or listen to the message. Since the message can be stored in one format and requested for reading (or listening) in a second format, a conversion function (not shown) is provided in the private network 208 (and/or public network) to convert the message from the one format to the other. As such, since the dialogue server 108 in FIG. 1 also includes a message format conversion function, access to the dialogue server 108 can be made from any one of the networks 202, 205, etc.

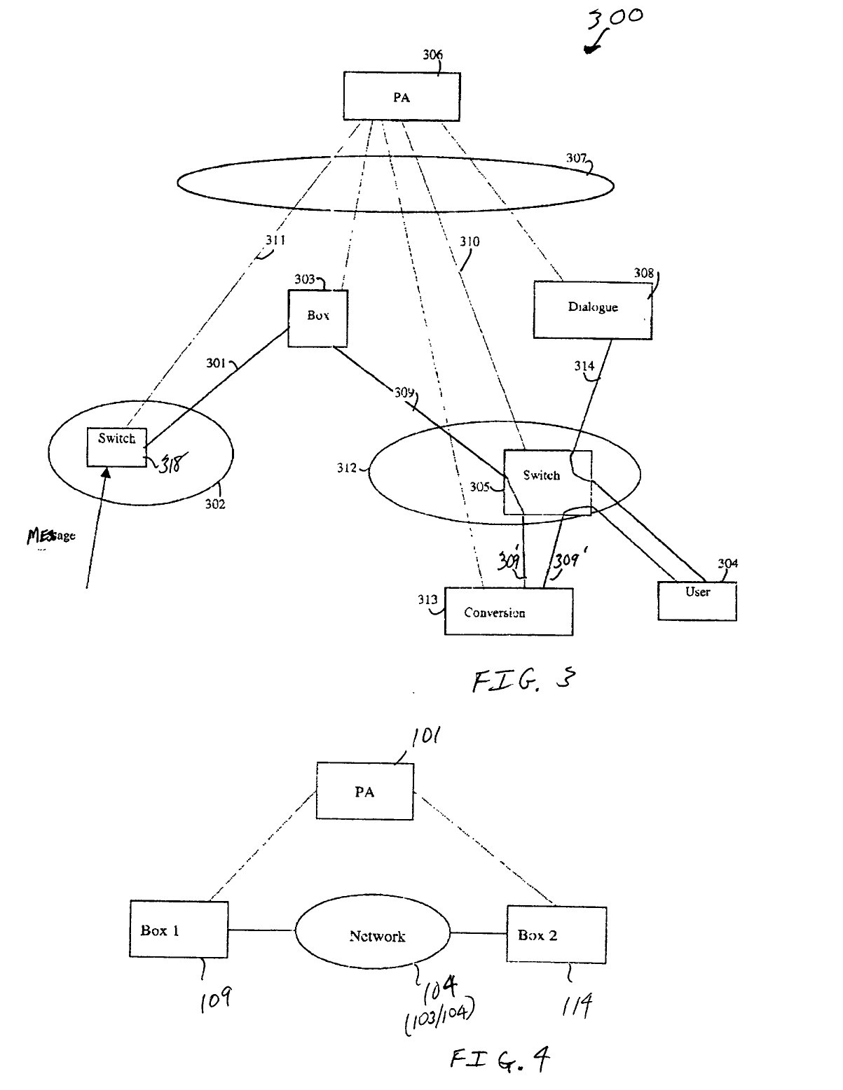

FIG. 3 is a simplified block diagram that illustrates an exemplary system 300 including a dialogue server 308 and a separate conversion server (or service node) 313, which can be used to implement a second embodiment of the present invention. Assume that a message for an intended recipient (e.g., user 304) has been stored in the message box 303 (under the control of PA 306) via the network node (e.g., switch) 318 in network 302, and the connection 301. The necessary switching functions for connecting the calling user (not shown) to the message box 303 can be controlled by the PA 306 through a signalling link 311 with network node 318. For example, the PA 306 can implement control of these switching functions in accordance with the European Computer Manufacturers Association (ECMA) Computer-Supported Telephony Applications (CSTA) standards, or by use of a conventional public switch. Also assume that the intended user 304 has been notified about the stored message (e.g., by a page message), and has requested a read out or retrieval of the message by placing a telephone call to the PA 306 via a network node (e.g., switch) 305 in network 312.

In response to the user's request, the PA 306 orders a dialogue server 308 (via the signalling network 307 and signalling connection 310) to set up a dialogue connection 314 with the intended recipient (user) 304. In this case, the user can be the receiver of the message. Notably, the PA 306 can also order the dialogue server 308 to set up a dialogue connection 314 for the user 304 as the sender of a message. As such, different dialogue servers can exist that offer different ways of interacting with the user and handling of dialogues via different types of terminals. For example (as mentioned earlier), the dialogue established in response to an incoming message can be directly with a person (e.g., voice message), or between two computers (i.e., through a “man machine interface” with a person). During the dialogue session, the intended user 304 can request a list of new messages, which request is communicated to and fulfilled by the PA 306.

In response to the user 304 selecting a message for reading (or listening), the PA 306 utilizes stored data about the message's address and attributes to order a connection 309 (using network node 305 to make the connection) to message box 303. For example, such a connection can be ordered and made in accordance with a method disclosed in above-described U.S. Pat. No. 5,555,298, and implemented in accordance with the aforementioned CSTA standard. Also, the PA 306 utilizes the stored message format and terminal type (in use by user 304) information to determine whether a format conversion is required. For example, the terminal type can be determined from the dialogue with the user at the time a message is accessed. If a format conversion is required, then the PA 306 orders the network node 305 to pass the connection 309 through the conversion server 313 to the user 304 via the connection 309′. As such, different conversion servers can exist that offer different sets of conversions.

For this exemplary embodiment, the conversion server 313 includes appropriate functionality which is capable of identifying the format of the stored message and the format which the user's network/terminal requires. As such, the conversion server 313 can determine just what type of conversion to perform, and then perform that conversion.

FIG. 4 is a simplified block diagram that illustrates a message transfer from one message box to another, which can be implemented in the exemplary embodiment shown in FIG. 1. In response to an intended recipient (user) of the message informing the PA 101 abut the user's location (e.g., nearest to message box 114), the PA 101 can control the establishment of a connection between one message box (e.g., 109) and the “closest” message box (e.g., 114) to the user via the network nodes (106, 115) in network 104. The PA 101 can then direct a transfer of the message(s) stored in the first message box (109) to the second message box (114) “closest” to the user's location via the network nodes (106, 115). Using a similar message transfer scheme (e.g., for redundancy and/or security purposes), the PA 101 can create a copy of the message(s) stored in the first message box (e.g., 109) and transfer the copy to the second message box (e.g., 114) via the network nodes (106, 115) in network 104.

Although a preferred embodiment of the method and apparatus of the present invention has been illustrated in the accompanying Drawings and described in the foregoing Detailed Description, it will be understood that the invention is not limited to the embodiment disclosed, but is capable of numerous rearrangements, modifications and substitutions without departing from the spirit of the invention as set forth and defined by the following claims.

What is claimed is:

1. In a telecommunications system including at least a service node coupled to a plurality of message boxes, a method comprising the steps of:
establishing a dialogue between a calling user and a dialogue server, said dialogue further establishing at least one condition for storing a message from said calling user, said message intended for a second user;
said at least a service node storing information associated with said message, said second user, and a selection of at least one of said plurality of message boxes; and
responsive to said stored information, said at least a service node rerouting a call from said calling user to said at least one of said plurality of message boxes, said call associated with said message.

2. The method of claim 1, wherein said at least a service node comprises a server.

3. The method of claim 1, wherein said at least a service node comprises a Personal Assistant.

4. The method of claim 1, wherein said information comprises authorization information.

5. The method of claim 1, wherein a cost for storing said message is incurred on a per system resource unit basis.

6. The method of claim 1, further comprising the step of storing said message in said at least one of said plurality of message boxes.

7. The method of claim 1, wherein the step of storing said information associated with said selection of at least one of said plurality of message boxes comprises reserving a message box for future use.

8. The method of claim 7, further comprising the step of storing said message in said reserved message box.

9. The method of claim 1, wherein said at least a service node initiates a prompt for said calling user to create said message.

10. The method of claim 1, wherein said message comprises at least a text message or verbal message.

11. The method of claim 1, further comprising the step of notifying said second user about said message and an identifier associated with said at least a service node and said message.

12. The method of claim 11, further comprising the step of said second user using said identifier to establish a call connection with said at least a service node.

13. The method of claim 12, further comprising the steps of:
transferring said identifier to said at least a service node; and
said at least a service node determining a network address corresponding to said at least one of said plurality of message boxes, and establishing communication between said calling user and said at least one of said plurality of message boxes.

14. The method of claim 13, wherein said communication between said calling user and said at least one of said plurality of message boxes is for receiving a message.

15. The method of claim 13, wherein said communication between said calling user and said at least one of said plurality of message boxes is for sending a message.

16. The method of claim 6, wherein the step of storing said message further comprises the steps of:
storing said message at a first message box; and
said second user retrieving said message from a second message box.

17. The method of claim 16, wherein said first message box is connected to said second message box by a data communications link.

18. A telecommunications system including a generic distributed message box, comprising:
a service node;
a plurality of message storage units, at least one of said plurality of message storage units coupled to said service node; and
at least one of a plurality of dialogue servers coupled to said plurality of message storage units, said service node operable to establish a dialogue between a calling user and said at least one of a plurality of dialogue servers, said dialogue further establishing at least one condition for storing a message from said calling user and intended for a second user;
said service node operable to:
store information associated with said message, said second user, and a selection of at least one of said plurality of message storage units; and
responsive to said stored information, reroute a call from said calling user to said at least one of said plurality of message storage units, said call associated with said message.

19. The telecommunications system of claim 18, wherein said service node comprises a server.

20. The telecommunications system of claim 16, wherein said service node comprises a Personal Assistant.
